(19) United States
(12) Patent Application Publication
(10) Pub. No.: US 2009/0103418 A1
(43) Pub. Date: Apr. 23, 2009

(54) OPTICAL DISK MEDIUM, INFORMATION RECORDING METHOD, AND OPTICAL DISK DRIVE

(75) Inventor: Atsushi Kikugawa, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/102,053

(22) Filed: Apr. 14, 2008

(30) Foreign Application Priority Data
Oct. 22, 2007 (JP) 2007-273582

(51) Int. Cl. G11B 7/135; G11B 7/24

(52) U.S. Cl. 369/112.01; 369/275.4

(57) ABSTRACT

Provided are an optical disk drive and a disk format necessary for the optical disk, which are capable of eliminating or reducing a problem of reduction in an effective transfer rate attributable to track jumps caused at a certain interval when performing recording and reproduction of multiple tracks in parallel by using multiple beams, and thereby achieving a high transfer rate. A block constituting a recording unit is divided into sub-blocks, and the sub-blocks are arranged in a radial direction of a disk. Meanwhile, an optical disk drive includes a means for irradiating a disk with multiple light spots, a means for pulse modulating the spots by using the same frequency and different phases, and a means for receiving light from the spots reflected by the disk by using a single photodetector, and separating the reflected light into independent lines of signals in terms of a time domain.

### CLAIM OF PRIORITY

The present application claims priority from Japanese application JP 2007-273582 filed on Oct. 22, 2007, the content of which is hereby incorporated by reference into this application.

### BACKGROUND OF THE INVENTION

1. Field of the Invention

The present invention relates to a format of an optical disk and to an optical disk drive.

2. Description of the Related Art

One of principal performances of an optical disk drive is a data transfer rate (hereinafter simply referred to as a “transfer rate”) at the time of recording or reproduction. The transfer rate is primarily determined by a linear recording density and by a linear speed of a disk. Meanwhile, the linear speed of a disk is restricted by a feasible rotational speed of the disk. In the case of a disk having a diameter of 12 cm and made of polycarbonate which is a material used for almost all optical disks, a limit of the rotational speed is deemed to be around 10000 rpm (rotations per minute). This is because a risk of disk destruction is increased in a rotational speed exceeding this level.

The linear recording density is primarily determined by optical resolution of a reproducing head, and is determined further in consideration of practical performance margins and an effect of an increase in performance attributable to signal processing. The optical resolution is determined by a wavelength of a light source used in the head and a numerical aperture of an object lens. Specifically, an upper limit of the transfer rate of the optical disk drive is solely determined by the upper limit of the feasible rotational speed of the disk and the linear recording density. As the above-mentioned factors are publicly known to those skilled in the art, further detailed description will be omitted herein.

The commercially available optical disk drive having the fastest rotational speed, as of August 2007, is a DVD drive capable of recording and reproducing at a maximum speed of 20×. Meanwhile, the consumer optical disk having the highest linear recording density which is commercially available as of August 2007 is a Blu-ray Disc (BD) having a capacity of 25 GB/side. It is deemed difficult to drastically improve these values in the future for both of the rotational speed and the linear recording density. That is, the improvement in the transfer rate of an optical disk drive is almost coming to its limit.

A conceivable countermeasure as an effective means for breaking through such a situation and for improving the transfer rate is to perform recording and reproduction on multiple tracks in parallel by using multiple beams. Japanese Patent Application Publication No. 2004-55131 discloses an example of a disk drive which is configured to perform reproduction by using multiple beams. As apparent from this publicly-known example, the transfer rate cannot be significantly improved when multiple tracks located adjacent to each other on an existing optical disk such as a CD, a BD or a DVD are reproduced at the same time. The primary reason is attributable to a fact that the tracks on the above-described optical disk are spirally arranged. Now, assume that two tracks adjacent to each other are now being reproduced in parallel by using two beams. In a first round, signals from the two different tracks can be obtained. However, when the disk finishes the first round, a spot on an inner peripheral side reaches a region where a spot on an outer peripheral side has just completed reproduction. If the reproduction is continued in this way, the transfer rate is eventually reduced to the same level as the reproduction using the single spot. It is necessary to perform track jump for each round in order to perform the reproduction by effectively using the two spots.

Naturally, data cannot be reproduced in the course of performing the jump. As a consequence, an average transfer rate is reduced by that period.

Moreover, how the jump is performed is another problem. An aspect thereof will be described by using FIG. 2. Now, assume that adjacent tracks 0 and 1 are going to be reproduced and that all the data starting from a block A(0) on the track 0 are to be reproduced. In the case of the above-described optical disk, all the blocks have the same length. Accordingly, the number of blocks to be contained in one round of a track varies depending on the radius, and therefore phases of starting positions of blocks between the adjacent tracks usually do not coincide with each other. For this reason, as shown in FIG. 2, the first block to be reproduced on the track 1 will be B(0) which has a different starting position of a phase from A(0). When the disk is rotated for one round and the phase returns to the original position, reproduction of the block immediately before B(0) (defined as B(n)) has not been completed. The disk needs to be rotated slightly more than one round in order to complete reproduction of B(n). Then at this point, the jump can be performed for the very first time. Since it is necessary to rotate the disk a little longer, the average transfer rate is reduced. Moreover, if the one-track jump is performed at this point, the reproduction cannot be started immediately at a destination of the jump, and therefore it is necessary to wait for rotation until a starting point of the block at the destination of the jump appears. This is another cause of the reduction in the average transfer rate.

Still another problem is that more hardware resources are required. A host device requires that the data be transferred in the order of addresses. However, if the CD, the BD or the DVD is reproduced at multiple spots, the spot on the outer peripheral side is performing a preceding process, which makes it impossible to transmit the data directly to the host device. Accordingly, it is necessary to buffer the data reproduced by the preceding spot and to transmit the data to the host device after rearranging the data in the order of addresses. An amount of precedence by the spot on the outer peripheral side relative to the inner peripheral side varies depending on the radius. The number of blocks per round increases as the track gets closer to the outer periphery. The more blocks are in a track, the more buffer memory is required. Moreover, it is also necessary to perform buffer control which can deal with variation in the amount of precedence.

The problems described above are caused because the existing optical disks are reproduced by using multiple spots, in spite of the fact that these optical disks have a physical format solely based on reproduction by using single spot. Therefore, it is expected that the above-mentioned problems can be avoided by improving the physical format of the disks. One example of such improvement is to wind a bundle of multiple tracks (grooves) spirally as disclosed in Japanese Unexamined Patent Application Publication No. Hei 4-255967. According to this method, it is unnecessary to perform the track jump for each round, or to perform the precedent buffer process by appropriately allocating the addresses. However, the worst weakness of this method is that it is extremely difficult to produce an original plate of the disk. Specifically, the original plate of the disk is produced by drawing groups or pits in one line by using an electron beam (or light). It is extremely difficult to deal with multiple tracks by use of these devices. Moreover, in the case of a recording-type disk, when multiple adjacent tracks are recorded simultaneously, there is an extremely high risk of causing thermal interference between the tracks

Due to the above-described problems, there have been few optical disk devices using the multiple spots which are commercially available in spite of numeral proposals released to date.

### SUMMARY OF THE INVENTION

A problem to be solved by the invention is to provide an optical disk drive and a disk format necessary for the optical disk, which are capable of eliminating or reducing a problem of reduction in an effective transfer rate attributable to track jumps caused at a certain interval when performing recording and reproduction of multiple tracks in parallel by using multiple beams, and thereby achieving a high transfer rate.

To solve the problem, according to the present invention, a block constituting a recording unit is divided into sub-blocks. Then, the sub-blocks that belong to the same block are arranged in a radial direction of a disk at intervals each including the same number of tracks. Moreover, the sub-blocks are also arranged in such a manner that the sub-blocks are shifted from each other in a circumferential direction of the disk at the same time.

Meanwhile, an optical disk drive according to the present invention includes: a means for irradiating a disk with multiple light spots; a means for pulse modulating the spots by using the same frequency and different phases, and a means for receiving light from the spots reflected by the disk by using a single photodetector and separating the reflected light into independent lines of signals in terms of a time domain.

By arranging the sub-blocks appropriately on the disk, according to the present invention, it is possible to provide an optical disk drive and a disk format necessary for the optical disk, which are capable of eliminating or reducing the problems of restriction of a liner speed attributable to a limit of a rotating speed of a disk, restriction of a linear recording density attributable to a limit of optical resolution, and reduction in an effective transfer rate attributable to track jumps caused at a certain interval when performing recording and reproduction on multiple tracks in parallel by using multiple beams, and thereby achieving a high transfer rate. Moreover, by devising a layout of the sub-blocks, it is possible to provide certain compatibility between drives using different numbers of spots. Further, by controlling light emission timing of the respective spots, a configuration of a pickup device can be simplified.

### BRIEF DESCRIPTION OF THE DRAWINGS

FIG. 1 is a view showing an embodiment of the present invention.

FIG. 2 is a view for explaining a problem of track jumps in a conventional format.

FIG. 3 is a view showing a zone layout.

FIG. 4 is a view showing inclination of an array of spots.

FIGS. 5A and 5B are views showing an influence of a defect.

FIG. 6 is a view showing a layout of sub-blocks for extending effective physical length of a block.

FIG. 7 is a view showing a layout of a control data region on a disk.

FIG. 8 is a view showing a layout of sub-blocks on a duplex drive format.

FIG. 9 is a schematic diagram showing a configuration example of a quadruple drive.

FIG. 10 is a view showing layouts of spots on a 4-quadrant photodiode.

FIG. 11 is a view for explaining a configuration to obtain tracking and focusing error signals with the quadruple drive.

FIG. 12 is a schematic diagram for explaining a process for producing bit sequence data of sub-blocks to be recorded.

FIG. 13 is a view showing a configuration example of a mechanism for restoring block data by using parallel-reproduced signals.

FIG. 14 is a view for explaining an aspect of restoring the block data.

### DETAILED DESCRIPTION OF THE EMBODIMENTS

Now, embodiments of the present invention will be described with reference to the accompanying drawings.

### First Embodiment

In the case of a recording-type drive, it is necessary to prepare the same number of light sources (lasers) as the number of spots. Various methods are conceivable for mounting the multiple lasers on a pickup device. However, two or four lasers are deemed to be practical in consideration of adjustability, a scale of a signal processing circuit, an operating frequency, and so forth. Accordingly, a case of setting a parallel number to four will be described below.

A disk format based on the present invention has the following features:
(1) the format is formed into a single spiral;
(2) one block includes four sub-blocks;
(3) the format includes zones defined by address ranges and a radius; the number of sub-blocks contained in one round is constant in the same zone; and
(4) the sub-blocks belonging to a certain block are arranged in a radial direction of a disk, and distances (the number of tracks) between the sub-blocks are also defined.

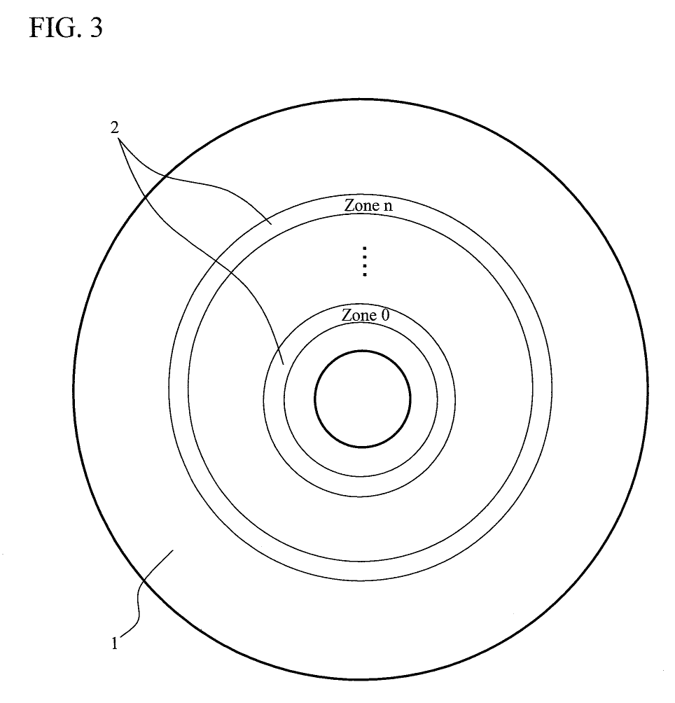

FIG. 3 shows a zone layout in a disk 1 applying the format based on the present invention. Each zone 2 has the same width and the same number of tracks included therein.

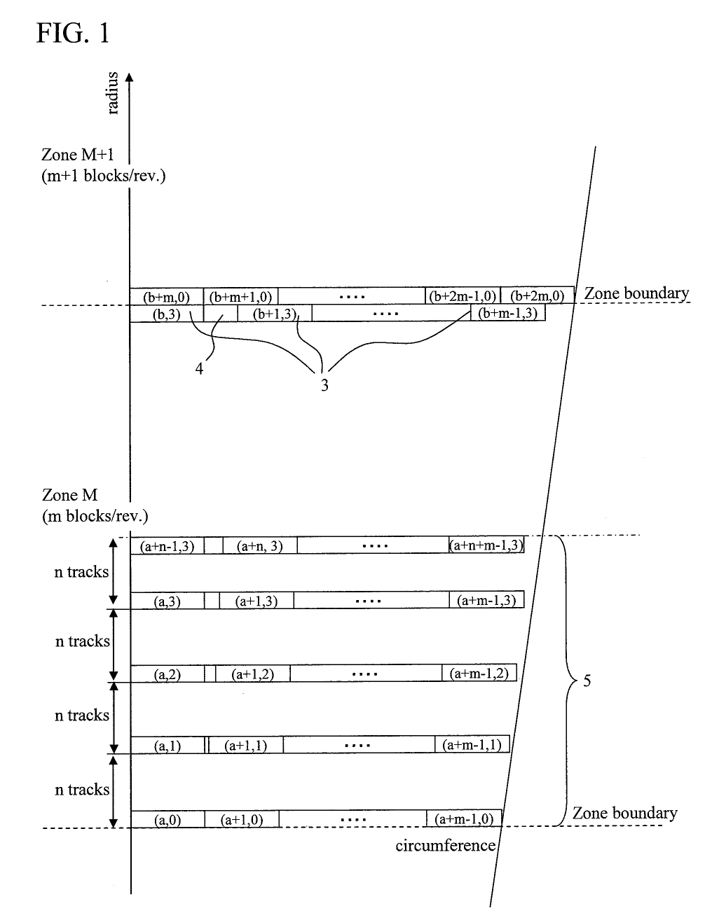

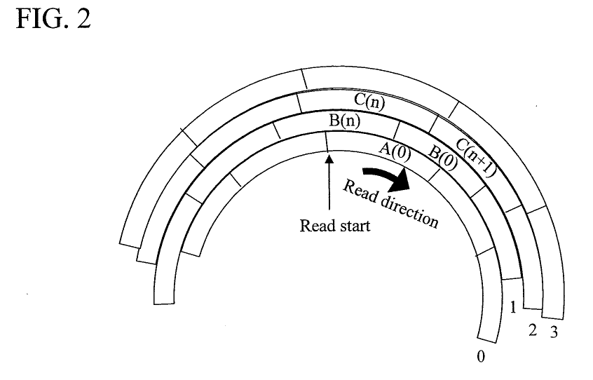

FIG. 1 schematically shows a spread layout of sub-blocks 3 in the format based on the present invention. As described previously, quadruple reproduction or recording is performed. In a zone M, one round of the disk contains m pieces of the sub-blocks. Practically, an address is attached to the sub-block in the form of a scalar value. However, a two-dimensional code such as (a, 0) is given thereto for the convenience of explanation herein. A suffix on the left side in the parenthesis identifies the block while a suffix on the right side identifies the sub-block. The sub-blocks that belong to the same block are each arranged in the radial direction of the disk, and an interval between the adjacent sub-blocks is set constant (n tracks). Therefore, it is unnecessary to perform a track jump for each round in the case of continuous reproduction from an inner peripheral side, but is only necessary to perform a track jump once in every n round. Since the frequency of the track jumps are less, decrease in an average transfer rate becomes less. Moreover, it is possible to read in the order of block addresses. Accordingly, unlike the disclosure in Japanese Patent Application Publication No. 2004-55131 it is unnecessary to perform a buffer process on data in a precedent block in the case of a drive configured to reproduce data from a disk having the format based on the present invention. Here, as shown in FIG. 1, a unit capable of being reproduced continuously without a track jump (4n tracks) will be called a bundle 5. The number of bundles contained in one zone is an integer, and every zone has the same number of bundles.

The length of the sub-blocks is constant, and the number of sub-blocks per round is also constant in the same zone. Accordingly, regions that are not used as the sub-blocks gradually increase as the zones come closer to an outer peripheral part. The unused regions may hamper reproduction and judgments as to whether the tracks are recorded or unrecorded if the regions are left unrecorded. Therefore, fixed patterns are recorded in the unused regions. Such a pattern will be called a filler 4. In the same round, the sub-blocks are arranged to have equal intervals, and spaces therebetween are filled with the fillers.

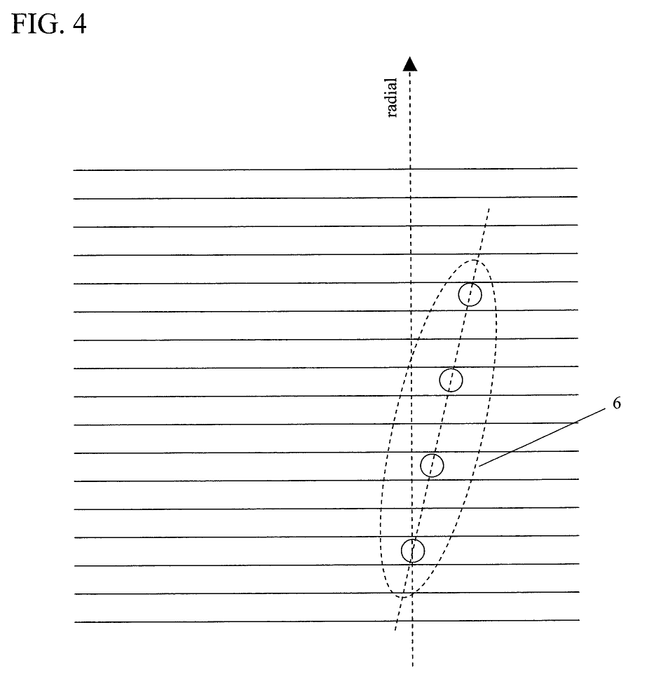

It is preferable to substantially align phases among the respective sub-blocks on the disk. However, it is difficult to align phases of respective spots in some cases. Specifically, the intervals between each spot need to be accurately aligned in an integral multiple of a track pitch. Accordingly, an array of a spot sequence 6 may be inclined relative to the radial direction as shown in FIG. 4 in order to adjust the pitch depending on the state of mounting the light sources. When a phase difference between each spot is small, the fillers provided between the corresponding sub-blocks constitute a buffer region. Meanwhile, when the phase difference is significant, in a case of recording, the phase difference is dealt by shifting the timing for starting recording light emission, for each spot.

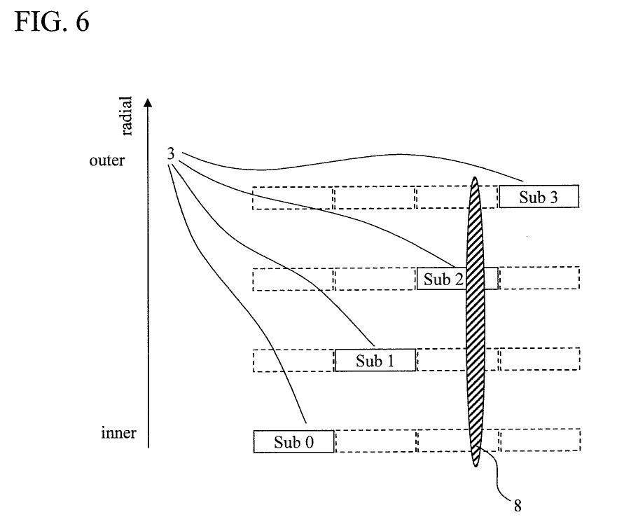

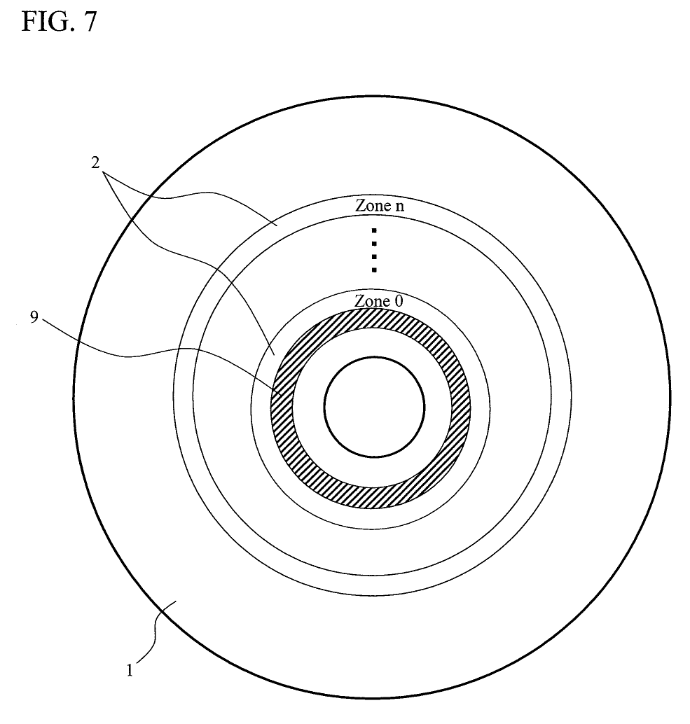

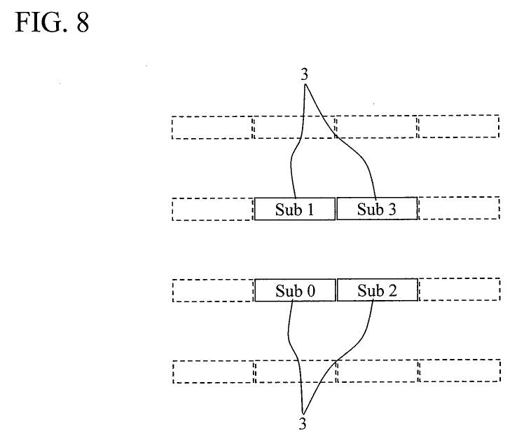

Conventionally, a position where a block designated by a certain physical address is recorded and a position to be recorded on a disk have a one-to-one relationship. The position on the disk is marked on the disk as a physical shape (a wobble) of a side face of the track, for example. However, in the case of the disk based on the present invention, the block is divided into four sections which are recorded in positions apart from each other. In other words, the physical address and the recorded position on the disk do not have the one-to-one relationship. Moreover, in this embodiment, indicators of recorded positions of the sub-blocks are called sub-block addresses. These are assigned in ascending order starting from the innermost radius, and are marked on the disk by use of group wobbles, like the conventional case. Specifically, prior to actual recording, four sub-block addresses are determined based on the physical address of the corresponding block and are then recorded. As shown in FIG. 1, the number of the sub-blocks and the positions are fixed. Therefore, conversion from the physical address to the sub-block addresses is unique. Here, there may be other formats of sub-block layouts different from FIG. 1 such as ones shown in FIG. 6 or FIG. 8 to be described later. In that case, of course, the four sub-block addresses are determined in consideration of the layout of the sub-blocks to be defined in each of the formats.

Next, a design example premised on an optical system equivalent to that of a Blu-ray Disc will be described. A user data capacity for one block is 64 kBytes while the size of a block organized by adding code correction information and address information is approximately 960000 bits. This is recorded by use of a 1-7 modulation method. A channel bit length is set to 74 nm. The number of sub-blocks per round is 8 on the innermost radius (24 mm) of a recordable region.

The number of spots used at the time of reproduction is 4. An interval between the spots in a cross-track direction is 8 tracks. Since a track pitch is set to 0.32 μm, an interval between the spots is 2.56 μm. Therefore, a distance between the spots at the innermost radius and the outermost radius is equal to 7.68 μm. A bundle width is set to 10.24 μm, and each zone includes 290 bundles. A zone width is set to 2.97 mm, and a side of the disk includes 11.44 zones. All the zones have the same width in principle. However, only the zone located on the outermost radius is set narrower due to restriction in the usable area of the disk.

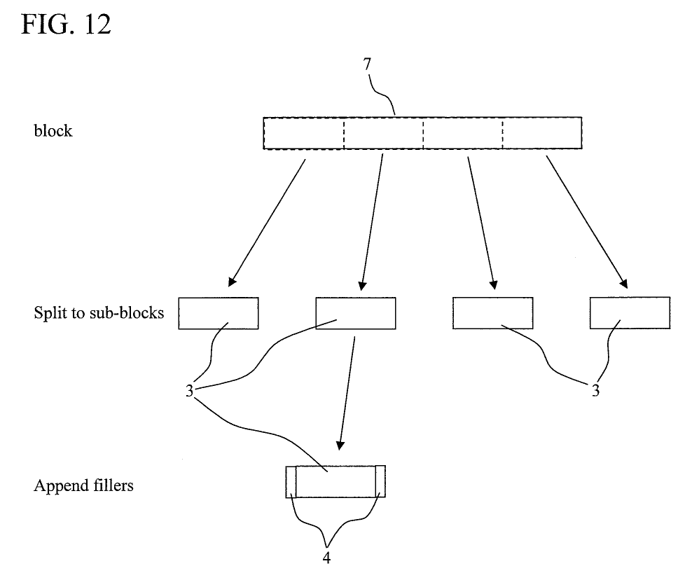

FIG. 12 schematically shows a process for producing bit sequence data to be actually recorded. A process for preparing block data is similar to the process with a conventional optical disk, in which interleave and code modulation are performed after adding a code correction code to user data. In this embodiment, a block bit sequence thus obtained is simply divided into quarters to form the sub-blocks. Each sub-block is added with a filler in front and the rear thereof, and thereafter, recording is performed. The recording is performed in a parallel manner by using four pieces of laser light sources. Here, when the sub-blocks are recorded in the format as shown in FIG. 6 or FIG. 8 to be described later, for example, even the sub-blocks belonging to the same block will be recorded with temporal delays.

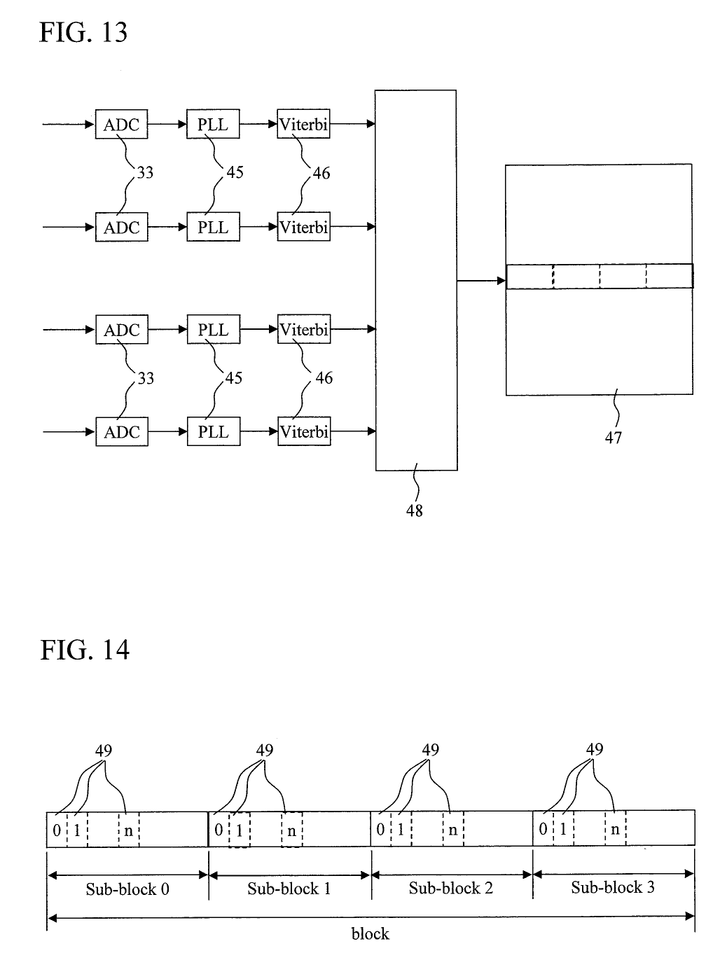

Note that a process to obtain the block from decoded bit sequence at the time of reproduction is a reversal of the foregoing process. An aspect thereof will be described by using FIG. 13. As shown in FIG. 13, signals from the respective sub-blocks obtained by parallel reproduction are inputted, and each signal is decoded into the bit sequence in parallel. Specifically, each inputted signal is discretized by ADC, passed through a PLL (phase-locked loop) 45, and then decoded into the bit sequence by a Viterbi decoder 46. This process is widely used for conventional optical disks, and detailed description will therefore be omitted. The bit sequence in each series thus decoded is inputted to a memory controller 48. The memory controller analyzes a pattern of each bit sequence thus inputted, identifies a frame from the bit sequence, and stores each frame into an appropriate position in a memory 47. The frame is defined in specifications for each type of the optical disks, and the concept thereof is widely and publicly known to those skilled in the art. The description will therefore be omitted here. FIG. 14 explains a process for restoring the block data in the memory. In FIG. 14, partitions inside the sub-blocks represent positions of frames 49. Meanwhile, numbers attached to the respective frames represent the ranks of the frames stored in the respective sub-blocks. Phases of the sub-blocks on the disk are almost aligned with one another. Accordingly, in many cases, the data are stored in the order of a frame rank 0 of a sub-block 0, a frame rank 0 of a sub-block 1, a frame rank 0 of a sub-block 2, a frame rank 0 of a sub-block 3, a frame rank 1 of the sub block 0, a frame rank 1 of the sub-block 1, a frame rank 1 of the sub-block 2, a frame rank 1 of the sub-block 3, and so on. Subsequent processes such as error correction of the block data thus restored may be the same as the related art.

### Second Embodiment

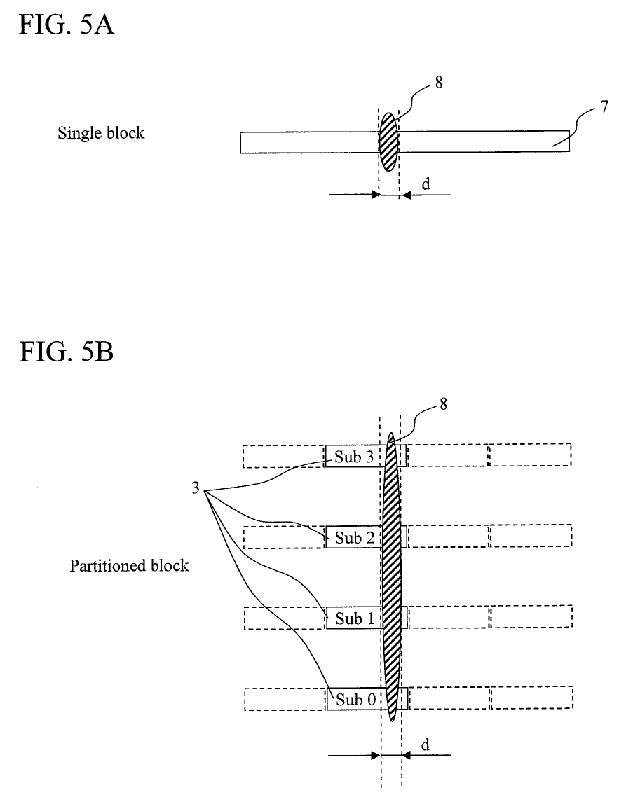

When all the sub-blocks belonging to a certain block are arranged in phase in the radial direction as described in the first embodiment, the block length in a circumferential direction becomes effectively shorter. Accordingly, an influence of a disk defect tends to become greater. Such an aspect will be described by using FIGS. 5A and 5B. As shown in FIG. 5A, assuming that there is a block 7 not divided into sub-blocks and that a defect 8 having a diameter of d exist therein, a length of the defect observed at the time of reproduction is naturally equal to d. Here, the size of d is estimated to be several millimeters.

Meanwhile, FIG. 5B schematically shows a case where all the sub-blocks belonging to a certain block are arranged in single phase in the radial direction like the first embodiment, and where a similar defect having a diameter of d exists therein. In the interest of drawing a figure, FIG. 5B is elongated in the radial direction (the vertical direction in the drawing). Since the sub-blocks are arranged in the radial direction, the range spreads more in the radial direction as compared to the case in FIG. 5A. However, as apparent from the example shown in the first embodiment, an absolute value of the radius covered by those sub-blocks is only several micrometers. As a consequence, all the sub-blocks have defects having the length approximately equal to d. In other words, the defect in the entire block is four times as long as the defect shown in FIG. 5A. Therefore, resistance to the defect is significantly degraded.

FIG. 6 shows an example of a sub-block layout for solving the above-mentioned problem. Specifically, the sub-blocks belonging to the same block are arranged not only in the radial direction but also so as to be shifted in the circumferential direction. In the example shown in FIG. 6, the sub-blocks on the outer peripheral side are sequentially shifted by one sub-block length. In this way, the effective physical length of this block becomes equivalent to four sub-blocks. Accordingly, if there is a defect as shown in FIG. 6, the defect does not affect all sub-blocks belonging to the same block, which is the case in FIG. 5B.

### Third Embodiment

In a case where numerous continuous blocks are reproduced, even when the sub-blocks are arranged so as to be shifted in the circumferential direction as shown in FIG. 6, there is little difference in the average transfer rate as compared to the case of laying out the sub-blocks in alignment with the radial direction. On the other hand, in the case of reproducing short data at random, for example, time required for outputting the data in the first block after starting the reproduction becomes four times longer than the case of arranging the sub-blocks in the radial direction. As a consequence, the advantage of parallel reproduction is deteriorated.

In the case of a disk based on the present invention, a user can select whether or not to apply the layout as shown in FIG. 6. Specifically, a layout mode of the sub-blocks can be selected when formatting the disk. The information is recorded in a control data region 9 disposed inside a zone 0 (the innermost zone). Based on this information, a drive configured to record and reproduce data on a formatted disk determines the layout of the sub-blocks at the time of recording as well as procedures of a buffer process for restoring a result of binarization of sub-blocks into a block at the time of reproduction. Here, recording and reproduction of the information in and out of the control data region is performed by using a single spot.

There is also prepared a method of ensuring compatibility between drives having different number of spots by utilizing variability of the sub-block layouts. Specifically, a drive configured to perform duplex recording and reproduction is easier to manufacture and available at a lower price as compared to a drive configured to perform quadruple recording and reproduction. By ensuring compatibility between these two drives, it is possible to offer more options for prices and performances to users.

FIG. 8 shows an example of a sub-block layout for a drive having two spots. Two sub-blocks having the same length and configuration as those in the case of the quadruple drives are continuously arranged in the circumferential direction. Compatibility is ensured by using the sub-blocks having the same length and configuration as those in the case of the quadruple drives. Specifically, when data is recorded on a disk in accordance with the sub-block layout in FIG. 8 with a two-spot drive, and when the recorded data is reproduced by use of a four-spot drive, only two spots out of the four spots may be used. Meanwhile, in order to record data by use of the four-spot drive so that the recorded data can be reproduced with the two-spot drive, the data may be recorded in accordance with the sub-block layout shown in FIG. 8 by using only the two spots. The information on the number of spots used at the time of recording and reproduction is also recorded in the control data region.

### Fourth Embodiment

In the case of reproduction using multiple spots, photodetectors for each spots, which are reflected at the disk, are usually prepared as in the example disclosed in Japanese Patent Application Publication No. 2004-55131. In this configuration, the reflected light from multiple spots needs to be adjusted to be incident on the corresponding photodetectors. Accordingly, it is more difficult to manufacture this configuration than to manufacture a conventional single-spot drive.

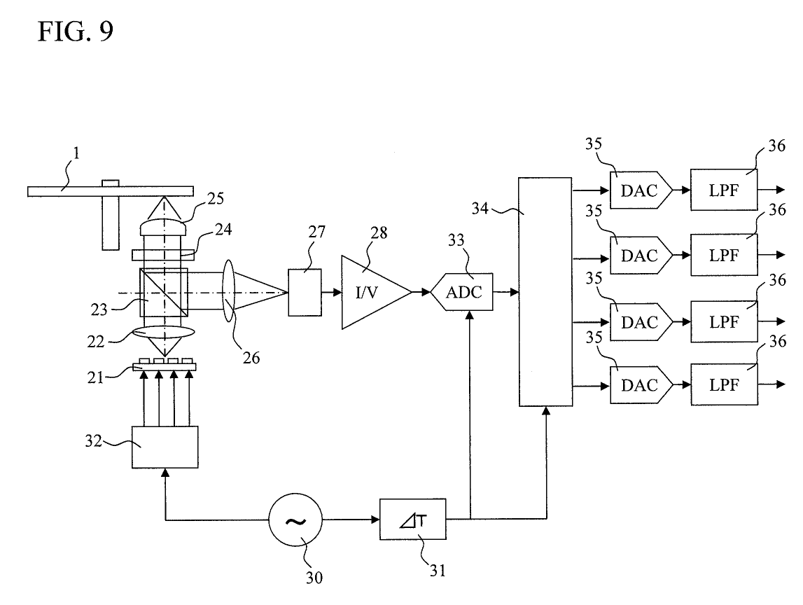

FIG. 9 shows a schematic configuration diagram of a drive configured to perform quadruple reproduction according to the present invention. In this drawing, constituents that are not essential for the following description are omitted, and a pickup section is mainly illustrated therein. This example shows a configuration to process the reflected light from the multiple spots by use of a single photodetector by means of applying the technique disclosed in Japanese Patent Application Publication No. 2007-73147.

A semiconductor laser used as a light source for an optical disk causes significant laser noise attributable to optical feedback. Pulsed light emission is performed in order to suppress such noise. This is publicly known to those skilled in the art, and therefore detailed description thereof will be omitted.

A clock source of the pulsed light emission is an oscillator 30. An oscillating frequency of the oscillator is four times higher than a required laser modulation frequency. An output (a clock) from the oscillator is inputted to a laser driver 32. The laser driver 32 includes a splitter. This splitter divides the inputted clock pulse into four clocks each having a phase delayed in an amount of T/4 by sequentially splitting the inputted clock pulse one by one into four series. Here, T is a clock cycle after splitting. Next, the laser driver outputs, to each split clock series, a laser drive current that can obtain desired average laser power, peak power, and duty, and then inputs the current to a laser diode array 21. Moreover, the laser driver also controls the laser drive current so as to maintain a constant average output of the laser.

The laser diode array includes four laser diodes, and four outputs from the laser driver are respectively connected thereto. Accordingly, each laser diode outputs a laser pulse having a different phase in the amount of T/4. Laser beams are converted into parallel light beams by a collimator lens 22. Then, after passing through a polarization beam splitter 23 and a quarter wavelength plate 24, the light beams are focused on a recording film surface of the disk 1 by an object lens 25. The laser beams are reflected by the recording film surface and form a reflected pulse laser line added with intensity changes corresponding to recorded marks and spaces. The reflected pulse laser line retraces the original pathway to the polarization beam splitter 23 and is then reflected by the polarization beam splitter 23, focused on a photodiode 27 by a focusing lens 26, and converted into an electric current.

The four-series light pulse trains each having a pulse interval of T reach the photodiode 27, with phase shifted from each other in the amount of T/4. Accordingly, an output from the photodiode is a pulse train formed of pulse trains each having a pulse interval of T/4. That is, the signals of the four series are time-multiplexed. The current outputted from the photodiode is converted into a voltage signal by a current to voltage conversion amplifier 28. The voltage signal is then converted into a digital signal by an ADC (analog to digital converter) 33. At this time, the timing of the AD conversion needs to be synchronized with the pulses and also needs to be set so as to obtain peak values of the pulses. To achieve this, the output from the oscillator is adjusted, by use of a variable delay line 31, such that a phase thereof satisfies the above-described condition, and is used as driving clocks for the ADC. Here, the photodiode and the current to voltage conversion amplifier have sufficient bandwidths for transmitting the laser pulses with little change.

An output from the ADC is inputted to a splitter 34. The splitter 34 splits the multiplexed signals of the four series into independent signals of the four series. Then, the respective signals thus split are converted into analog signals by DACs (digital to analog converters) 35. Since outputs from the DACs are stepwise waveforms, unnecessary higher harmonics are removed therefrom by use of low-pass filters 36 to obtain smooth reproduction signals. Although description is omitted in FIG. 9 in order to avoid complication and because it is easily understood by those skilled in the art, driving clocks (the cycle: T) for the DACs are simultaneously outputted from the splitter 34.

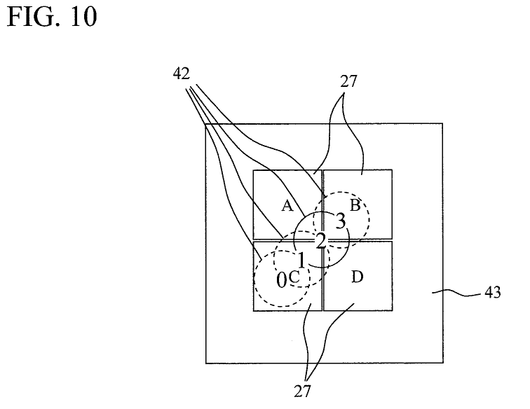

Note that the drawings and explanations are given above using the undivided photodiode for simplifying the description. A 4-quadrant photodiode is used for obtaining tracking and focusing error signals. FIG. 10 shows the shape of a tetrameric photodiode 43 and an adjustment example of spot positions thereon. The 4-quadrant photodiode 43 includes four photodiodes 27 which are arranged in a lattice fashion as shown in FIG. 10. In the case of a conventional one-spot drive, a spot 42 is adjusted such that light is evenly irradiated on the four photodiodes. In the case of a drive having multiple spots, each spot is located in different position on the photodetectors. In order to obtain the focusing and tracking error signals, one of these spots may be arbitrarily selected for use. In the example shown in FIG. 10, a spot “2” is selected from spots “0” to “3,” and the spot “2” is adjusted to cover the four photodiodes evenly. Since the spot is pulsed light, it is possible to obtain the focusing and tracking error signals by a similar method to the related art by extracting signals in accordance with the timing of the pulse of the spot “2”.

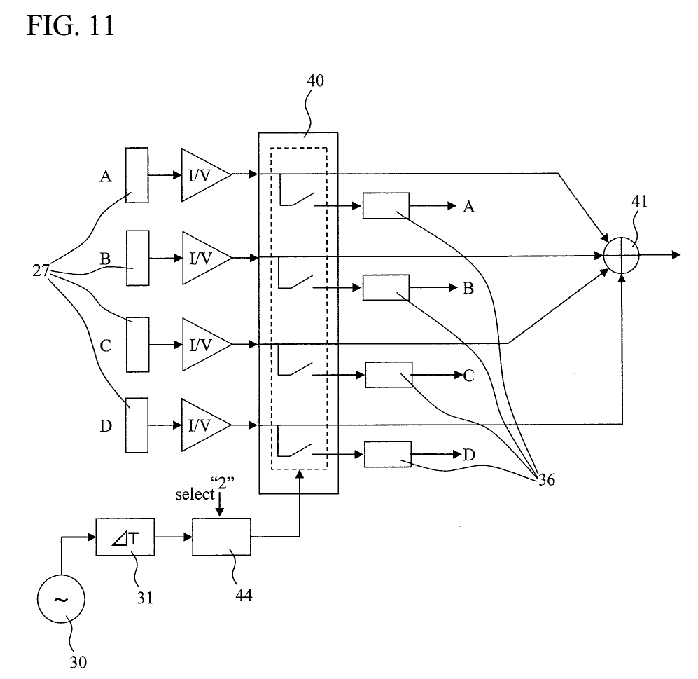

One of the examples is shown in FIG. 11. Outputs from four photodiodes respectively named as A, B, C, and D are converted into voltage signals respectively by use of four independent current to voltage conversion amplifiers. Like the above-described example, the photodiodes and the current to voltage conversion amplifiers have sufficient bandwidths for transmitting the laser pulses with little change. Respective outputs from the current to voltage conversion amplifiers are inputted to a sampling switch 40. The sampling switch 40 extracts only the pulses of the spot “2” out of the outputs from the current to voltage conversion amplifiers and outputs the pulses to the low-pass filters 36. A cutoff frequency of the low-pass filter 36 may be equivalent to that of the conventional drive. The operation timing of the sampling switch 40 is obtained from the driving clocks of the lasers. Concerning a phase difference between the pulse and the clock, the phases are adjusted by use of a delay adjuster 31. A timing selector 44 is a sort of a splitter which outputs, in this case, only the clock pulses at the timing corresponding to the pulses of the spot “2” among the clocks split into the four series. It is easily understood by those skilled in the art that the focusing and tracking error signals equivalent to the conventional single-spot drive are thus obtainable in the way described above.

Here, after passing through the current to voltage conversion amplifiers and the sampling switch 40, the outputs from the four photodiodes including the pulses of the spot “2,” are added together by an adder 41. In this example, an output from this adder 41 corresponds to the output from the current to voltage conversion amplifier 28 in FIG. 9. Subsequent processes are similar to the previous description and will therefore be omitted herein. Alternatively, the pulses of the spot “2” may be extracted after the outputs from the respective current to voltage conversion amplifiers are converted into digital signal by using four ADCs.

Although the number of the spots is set to four in this embodiment, it is also possible to set a larger number. Conceivable factors for restricting the feasible number of spots include a scale of a signal processing circuit, a field of view of an object lens of a pickup device, and so forth. It is difficult to define an upper limit of the number of the spots definitely. However, considering future improvement in performances of semiconductors, it is likely that an increase in the number of the spots up to 8 or 16 is feasible.

The present invention is broadly applicable to optical disks (recording media) and optical disk drives.

What is claimed is:

1. An optical disk medium provided with a guide groove formed of a single spiral, the optical disk medium comprising a plurality of sub-blocks formed by splitting a single block, wherein
the plurality of sub-blocks are dispersed and arranged in a radial direction of the disk at intervals each including the same number of tracks.

2. The optical disk medium according to claim 1, wherein
the plurality of sub-blocks are arranged in such a manner that the sub-blocks are shifted from each other at given intervals in a circumferential direction of the disk.

3. The optical disk medium according to claim 1, wherein
some of the plurality of sub-blocks are set together as one set, and are continuously arranged on a same track.

4. The optical disk medium according to claim 1, further comprising
a plurality of zones each having a predetermined width in the radial direction, wherein:
the number of sub-blocks per track is the same in each of the zones; and
the numbers of sub-blocks per track are different between the different zones.

5. The optical disk medium according to claim 1, wherein:
the sub-blocks are arranged on each of the tracks while being equally spaced from one another; and
a filler is disposed in a space between each adjacent two of the sub-blocks on each of the tracks.

6. An information recording method for recording information on an optical disk medium provided with a guide groove formed of a single spiral, the method comprising the steps of:
dividing a block constituting a recording unit into a plurality of sub-blocks; and
recording, by using a plurality of light sources, the plurality of sub-blocks that are dispersed in a radial direction of the disk at intervals each including the same number of tracks.

7. The information recording method according to claim 6, wherein
the plurality of sub-blocks are recorded in parallel by use of the plurality of light sources.

8. The information recording method according to claim 6, wherein
the plurality of sub-blocks are recorded while being arranged in such a manner that the sub-blocks are shifted from one another at given intervals in a circumferential direction of the disk.

9. The information recording method according to claim 6, wherein
some of the plurality of sub-blocks are set together as one set, and are continuously recorded on a same track.

10. The information recording method according to claim 6, wherein:
a plurality of zones are set on the optical disk medium;
the number of the sub-blocks to be recorded on each track is the same in each of the zones; and
the numbers of the sub-blocks to be recorded on each track are different between the different zones.

11. The information recording method according to claim 6, wherein:
the sub-blocks are recorded on the respective tracks while being equally spaced from one another; and
a filler is recorded in a space between each adjacent two of the sub-blocks on each of the tracks

12. An optical disk drive comprising:
a plurality of laser light sources;
a driving signal source configured to drive, with pulses, the plurality of laser light sources sequentially;
an optical system configured to irradiate an optical disk with laser beams emitted from the plurality of laser light sources, the laser beams being arranged at intervals each including the same number of tracks.
a photodetector configured to receive the laser beams reflected by the optical disk;
a means for converting an output from the photodetector into an electrical pulse reproduction signal; and
a means operated synchronously with pulses in the pulse reproduction signal for temporally splitting the pulse reproduction signal sequentially into series in the same number as the number of the laser beam sources, and then converting the split signals into a temporally continuous reproduction signal.

13. The optical disk drive according to claim 12, wherein:
the photodetector is a tetrameric photodetector; and
the photodetector comprises a means for extracting, as four outputs of the tetrameric photodetector, only one designated series of the pulse reproduction signals.
